(19) United States
(12) Patent Application Publication
(10) Pub. No.: US 2008/0262808 A1
(43) Pub. Date: Oct. 23, 2008

(54) METHOD FOR DIMENSIONING INDUSTRIAL INSTALLATIONS WHERE A TWO-PHASE GAS-LIQUID MIXTURE FLOWS IN AN INTERMITTENT REGIME

(76) Inventors: Sebastien GUET, Meylan (FR); Sandrine Decarre, Rueil-Malmaison (FR); Alain Line, Castanet-Tolosan (FR)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/108,026

(22) Filed: Apr. 23, 2008

(30) Foreign Application Priority Data
Apr. 23, 2007 (FR) 07/02.939

(51) Int. Cl. G06F 17/10; G06G 7/50

(52) U.S. Cl. 703/2

(57) ABSTRACT

Method for dimensioning industrial installations where a two-phase gas-liquid mixture flows in an intermittent regime.

The flow behavior is modeled for each phase within a gas pocket and a liquid slug with the help of physical models. The flow of a gas flow entrained behind a gas pocket is also measured with the help of a physical model. It is considered for this model that the pressure variation between the rear of a gas pocket and a liquid slug behind this pocket is responsible for the entrainment, and a critical condition for the entrained gas flow is taken into account. The load losses within the pipe are then determined with the help of an iterative method in which this entrained gas flow thus modeled is adjusted with an average gas flow obtained by a conversion equation for flows in established intermittent flow behavior. The dimensions for industrial installations are thereby determined that minimize load losses.

Application to the transport of petroleum fluids and in particular to the dimensioning of production pipes, risers, etc.

This invention concerns the field for the extraction and the transport of petroleum effluents.

In particular, the invention concerns a method for dimensioning industrial installations where petroleum effluents, consisting of a liquid phase and a gaseous phase, flow in an intermittent regime.

### PRESENTATION OF PRIOR ART

In the petroleum industry, it is extremely important to correctly dimension industrial installations for extraction and transport of petroleum effluents. In order to do this, it is necessary to anticipate the load losses due to the multiphase flow behaviors in these types of pipes.

In general, the flow of petroleum effluents is a flow comprising a liquid phase and a gaseous phase. This two-phase flow can then present different regimes:
stratified flow: this is a flow with separated phases.
dispersed flow: this deals with, for example, a flow of liquid in which bubbles are formed.
annular flow: this is a flow with separated phases in which the liquid completely coats the wall in the form of an annular film around the gas flow.
intermittent or slug flow.

The invention concerns more particularly this last type of flow behavior. An intermittent flow is observed for “average” outputs of gas and of liquid. Its structure presents a succession of gas pockets, called Taylor pockets, and liquid slugs that can contain small gas bubbles. It is a mixed configuration between a stratified flow and a dispersed flow.

In this configuration it can produce a phenomenon of gas entrainment, the gas being entrained behind the gas pocket around the liquid slug in the form of millimeter sized bubbles. The fraction of gas in the liquid slug depends in that case on the flow of entrained gas behind the pocket. The rear of the pocket is defined relative to the flow direction of the effluent (flow from the rear to the front). The rear therefore corresponds to upstream (downstream being the front).

In order to be able to estimate the load losses of this type of flow (two-phase intermittent), it is necessary to calculate the average void fraction, which itself acts to have an affect on the void fraction in the gas pockets and the average void fraction in the liquid slugs. The ratio between the volume occupied by the gas and the total volume of the mixture is called the void fraction of a gas-liquid mixture.

To calculate the void fraction in the liquid slug, an empirical calculation is widely used. Recent publications that can be cited as using this approach are:
Felizola, H., Shoham, O. 1995. A unified model for slug flow in upward inclined pipes. Journal of Energy Resources and Technology, 117, pp 7-12.
Gomez, L. E., Shoham, O., Taitel, Y. 2000. Prediction of slug liquid holdup: horizontal to upward vertical flow. International Journal of Multiphase Flow, 26, pp 517-521.

A method based on physical models is also known for calculating the void fraction in the liquid slug and the gas pocket. This method employs a physical model for the flow of gas entrained behind the gas pocket (in a reference mark that is moving at the velocity of the pocket). In this model, the entrained gas flow model is based on the hypothesis that a turbulent jet of liquid, present behind the pocket, is responsible for the entrainment of the gas. However, as the following document shows, the results associated with different properties of fluids present show that it can lead to inconsistencies and does not give a refined description of the void fraction.
Brauner, N, Ullmann, A. 2004. Modeling of gas entrainment from Taylor bubbles. Part A: slug flow. International Journal of Multiphase Flow, 30, pp 239-272.

In short, neither method allows estimating the load losses for an intermittent two-phase flow in a precise manner, and in particular neither method takes into account the effects of gas entrainment behind the gas pocket. These effects are important because the aeration of the liquid slug significantly influences the load losses. And the determination of load losses is indispensible for determining the dimensions of installations such as petroleum effluent pipes.

Thus, the purpose of the invention is a method for dimensioning industrial installations where petroleum effluents, consisting of a liquid phase and a gaseous phase, flow in an intermittent regime. At the heart of this method, load losses within installations (extraction pipes, effluent transport pipes, etc.) are estimated by taking into account the wrenching effects of gas behind the gas pocket.

### The Method According to the Invention

The invention concerns a method for dimensioning industrial installations where a two-phase mixture comprising a liquid phase and a gaseous phase flows according to a configuration comprising a succession of liquid slugs and gas pockets behind which gas is entrained, in which the flow behavior for each phase within a gas pocket and the flow behavior of each phase within a liquid slug are modeled with the help of a first physical model, and the entrained gas flow is modeled with the help of a second physical model. The method comprises the following steps:
the second physical model is defined in which said entrained gas flow is proportional to a pressure variation between a gas pocket and a liquid slug behind this pocket, and in which a critical condition for formation of said entrained gas flow is taken into account, defined by a pressure variation such that pressure forces generated by this pressure variation are greater than the surface tension forces between the gas and the liquid;
said second model is initialized and calibrated with the help of experimental measurements;
a pressure gradient in the pocket, a pressure gradient in the slug and the ratio of one gas pocket length over one liquid slug length are determined with the help of an iterative method within which an entrained gas flow Ψ_{G,ent} is adjusted, calculated with the help of said second model, with an average gas flow Ψ_{G} obtained by a flow conservation equation of the intermittent flow established from said first physical flow model,
load losses within industrial installations are determined with the help of said pressure gradients and said ratio, and
the dimensions of industrial installations are determined so as to minimize said load losses.

According to the invention, the entrained gas flow Ψ_{G,ent} can be determined by considering that a rate K_{ΔP} of the work done by the pressure forces is used for the gas entrainment. In order to determine the entrained gas flow Ψ_{G,ent}, a maximum value can also be taken into account for the entrained gas flow, through a hypothesis of uniform and non-drifting flow.

The first physical model can comprise either a stratified flow model based on the equality of pressure gradients in the two phases, or a annular flow model based on the equality of pressure gradients in the two phases. It can furthermore comprise a drifting flow type model.

A stopping criterion for the iterative method can by defined by the following convergence criterion:

|(Ψ_{G,ent}−Ψ_{G})/Ψ_{G}|<10⁻³

According to the invention, the dimensions of industrial installations are determined by determining the load losses for different values of given geometric properties of installations, and those installations are selected having geometric properties minimizing the load losses.

This method is particularly well adapted for the dimensioning of industrial installations such as those for petroleum effluent pipes, or for slug-catcher type petroleum separation equipment. In the second case, the dimensions of this separation equipment is determined by determining the gas and liquid fractions and the relative lengths of a pocket and a liquid slug.

Other characteristics and advantages of the method according to the invention shall become apparent with the reading of the following non-restrictive embodiments by referring to the attached drawings, which are described below.

### BRIEF DESCRIPTION OF THE DRAWINGS

FIG. 1 is a diagram presenting the various stages of the evaluation method for load losses.

FIG. 2 illustrates the principle of the physical model for the entrainment of the gas flow.

FIG. 3 shows a prediction of the average void fraction according to the measurement, for a condensate flow in a pipe included at θ=45°.

FIG. 4 shows a prediction of the average void fraction according to the measurement, for a condensate flow in a pipe included at θ=75°.

### DETAILED DESCRIPTION OF THE METHOD

The invention concerns a method for dimensioning industrial installations in which a two-phase mixture, comprising a liquid phase and a gaseous phase, flows with an intermittent flow behavior, which is to say a flow comprising a succession of gas pockets and liquid slugs, in which a flow of gas is entrained behind the gas pockets. The rear of the pocket is defined relative to the flow direction (flow from the rear to the front).

The method comprises a physical modeling of this type of flow, then an estimation of the load losses within the pipe. Finally, the appropriate dimensioning of the installations is deduced from the load losses.

The method is based on the equality between the entrained gas flow behind the gas pocket and the gas flow obtained by the conservation equation for flows in established intermittent flow behaviors. The gas pocket of the flow is modeled with the help of a stratified flow model and the liquid slug zone is modeled by a drift flux approach. The gas flow entrained behind the pocket is expressed with the help of a physical approach by involving the velocities and void fractions in the different areas of the flow. The equality between the gas flows allows closing the problem and obtaining the average void fraction.

First, the physical models allowing the modeling of the flows are presented. Then the iterative method allowing the determination of the load losses is described.

### Physical Modeling of Gas-Liquid Intermittent Flows

The invention concerns intermittent-type two-phase gas-liquid flows. It is recalled that an intermittent flow is separated into two areas: a gas pocket (P) and a liquid slug (B). In order to model these flows, they are characterized by the following parameters:

Concerning the gas pocket:
the velocity of the gas pocket V_{P}
the average void fraction on the pocket section R_{GP}
the liquid fraction in the pocket R_{LP}
the average velocity of the gas in the pocket V_{GP}
the average velocity of the liquid in the pocket V_{LP}

Concerning the liquid slug:
the average void fraction on the slug section R_{GB}
the liquid fraction in the slug R_{LB}
the average velocity of the gas in the slug V_{GB}
the average velocity of the liquid in the slug V_{LB}

As well as:
the average void fraction on the total section R_{G}
the average liquid fraction on the total section R_{L}
   According to the invention, a physical model is made of the gas-liquid intermittent flows by defining three physical models:
a first physical model (PM) describing the flow of each phase within a gas pocket (P),
a second physical model (MB) describing the flow of each phase within a liquid slug (B),
a third physical model (MF) describing the flow of gas entrained behind the pocket.

### Physical Model (MP) Describing the Flow in the Gas Pocket (P)

The flow in the gas pocket (P) is modeled with the aid of a physical model making use of the void fraction in the pocket (R_{GP}), the liquid fraction in the pocket (R_{LP}), the average velocity of the gas in the pocket (V_{GP}) and the average velocity of the liquid in the pocket (V_{LP}).

According to the invention, it is considered that the gas flow behavior in the gas pocket is stratified in an inclined pipe and annular in a vertical pipe. So the model is based on the equality of pressure gradients in the two phases. By combining the conservation equations of the linear momentum for the gas and for the liquid in order to eliminate the pressure gradient, we get:

((pe/S)[R_{LP}τ_{GP}χ_{GP}−R_{GP}τ_{LP}χ_{LP}+τ_{GLP}χ_{GLP}])−(ΔρR_{GP}R_{LP}gsinθ)=0 (8)

### With:

pe: the perimeter of the pipe
S: the section of the pipe
χ_{LP}: the perimeter covered by the liquid (non-dimensional)
χ_{GP}: the perimeter covered by the gas (non-dimensional)
χ_{GLP}: the gas-liquid interfacial perimeter (non-dimensional)
τ_{LP}: the partial stress due to the liquid. This is a function of V_{LP}, R_{LP}, χ_{LP}
τ_{GP}: the partial stress due to the gas. This is a function of V_{GP}, R_{LP}, χ_{GP}
τ_{GLP}: the gas-liquid interface stress in the area of stratified flow. This is a function of V_{GP}, R_{LP}, χ_{GLP}
Δρ: difference of densities [kg/m^{3]}
θ: angle of the pipe with the horizontal [rad]
   In addition, the velocity of the gas pocket V_{P}, is calculate by the following relationship:

V_{P}=C_{P}Uₘ+V_{drift,P}, (7)

with:
D: diameter of the pipe [m]
Uₘ: surface velocity of the mixture
V_{drift,P}: relative velocity of the pocket in ratio to the mixture and where the coefficient C_{P} and the velocity V_{drift,P} are a function of Uₘ, θ, D and are given by models from the literature, such as are described in the following documents:
Fabre J., Liné A. 1996. Slug flow modeling. International encyclopaedia of heat and mass transfer. Innodata corp., 1015-1021.

### Physical Model (MB) Describing the Flow in the Liquid Slug (B)

The flow behavior in the liquid slug (B) is modeled with the help of a physical model making use of the void fraction in the slug (R_{GB}) and the average velocity of the gas in the slug (V_{GB}).

In the liquid slug, the velocity of the dispersion of bubbles, that is to say the average velocity of the gas in the liquid slug (B), can be modeled by an drift-flux approach. This approach is described, for example, in the following document:
Zuber, N., Findlay, J. A. 1965. Average volumetric concentration in two-phase flow systems. J. Heat Transfer Trans. ASME Ser., 87, pp 453-468.
   According to this model, we write:

V_{GB}=C_{0B}Uₘ+V_{drift}, (6)

Where C_{0B}, a function of R_{GB} and θ, and V_{drift}, a function of θ, are given by models from the literature. For example, one may refer to:
Guet, S., Ooms, G., Oliemans, R. V. A., Mudde, R. F. 2004. Bubble size effect on low liquid input drift flux parameters. Chemical Engineering Science, 59, pp 3315-3329.

### Physical Model Describing the Flow of Gas Entrained Behind the Pocket

The flow of gas entrained behind the gas pocket (P) is modeled with the help of a physical model. It is recalled that the rear of the pocket is defined relative to the flow direction (flow from the rear to the front).

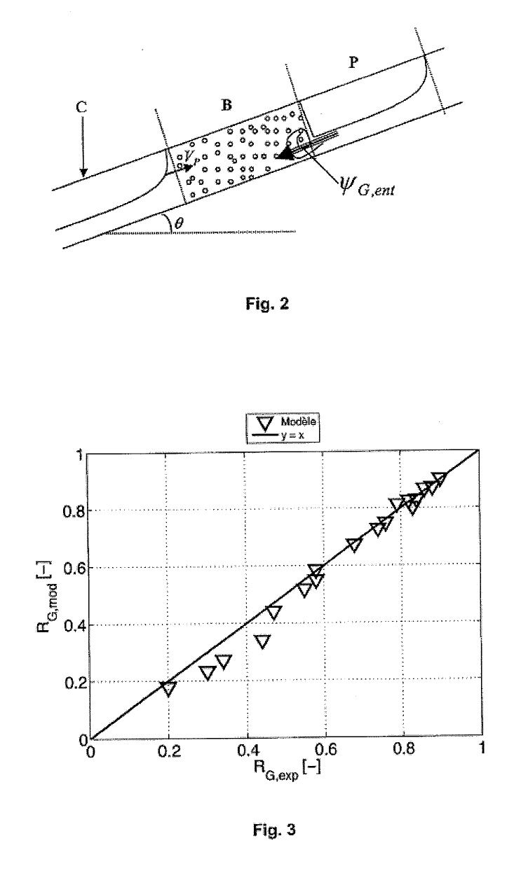

FIG. 2 illustrates the principle of the physical model entrained gas flow Ψ_{G,ent} according to the invention: the flow in the pipe C, inclined at an angle θ with the horizontal, comprises two sections: a gas pocket (P) advancing at the velocity V_{P}, and a liquid slug (B).

It is assumed that the flow is developed and at the equilibrium state. The gas and liquid flows are thus equivalent at each boundary of the flow.

In an established flow behavior, this entrained gas flow Ψ_{G,ent} is equivalent to the gas flows calculated by assessment on each section (P and B) of the flow (Ψ_{GP} and Ψ_{GB}), and to the average gas flow Ψ_{G}. The average gas flow is the gas flow obtained by the conservation equation of flows in an established intermittent flow behavior: Ψ_{G}=R_{G}(V_{P}−V_{G}), V_{G} being the average velocity of the gas.

Ψ_{G}=Ψ_{GP}=Ψ_{GB}=Ψ_{G,ent} (1)

The gas flows are given by:

$$\{ \begin{matrix}{ψ}_{G} = {R}_{G} ( {V}_{P} - {V}_{G} ) \\ {ψ}_{GB} = {R}_{GB} ( {V}_{P} - {V}_{GB} ) \\ {ψ}_{GP} = {R}_{GP} ( {V}_{P} - {V}_{GP} )\end{matrix} \qquad ( 2 )$$

These flows are given in a referential system, moving at the pocket velocity V_{P}. The model according to the invention employs the same type of equality on the flows for the liquid phase:

Ψ_{L}=Ψ_{LP}=Ψ_{LB} (3)

The liquid flows are given by:

$$\{ \begin{matrix}{ψ}_{L} = {R}_{L} ( {V}_{P} - {V}_{L} ) \\ {ψ}_{LB} = {R}_{LB} ( {V}_{P} - {V}_{LB} ) \\ {ψ}_{LP} = {R}_{LP} ( {V}_{P} - {V}_{LP} )\end{matrix} \qquad ( 4 )$$

The void and liquid fractions are furthermore linked by the equalities:

$$\{ \begin{matrix}{R}_{G} + {R}_{L} = I \\ {R}_{GP} + {R}_{LP} = I \\ {R}_{GB} + {R}_{LB} = I\end{matrix} \qquad ( 5 )$$

Under certain conditions, some of the gas is entrained from the gas pocket to the liquid slug in the form of millimeter-sized bubbles. This leads to a non-zero value of the void fraction in the liquid slug (R_{GB}≢0). In a sliding reference mark moving at the velocity of the pocket (V_{P}), the entrained gas flow is written Ψ_{G,e}. The average velocities of the phases being very different in the gas pocket area and in the liquid slug area, the effects of the gas entrainment can be attributed to two phenomena.
The turbulent agitation in the liquid in the rear area of the pocket, due to the turbulent get of liquid (Brauner et Ullmann, 2004),
the jump in hydrodynamic pressure, necessary to accelerate the liquid from the gas pocket to the liquid slug.
   According to the invention the flow Ψ_{G,e} of gas entrained behind the gas pocket (P) is modeled with the help of a physical model (MF). In this model, it is considered that the flow is proportional to a source of energy and that the pressure jump behind the pocket is the source of energy responsible for the entrainment of gas behind the pocket. The pressure jump necessary to accelerate the liquid between the gas pocket and the slug is given by: ΔP=ρ_{L}Ψ_{L}(V_{LB}−V_{LP}). The aeration of the liquid slug is governed by a competition between this pressure force ΔP and the force due to the surface tension, τ=(σ/d_{Max}).

σ: gas-liquid surface tension [N/m]

d_{Max}: maximum size of the bubbles

Otherwise, with weak velocities being delivered, the liquid slug is frequently not aerated, so that the flow of entrained gas is zero. The existence limit for entrainment is described by the ratio of these two forces,

$${[ \frac{Δ P}{{τ}_{σ}} ]}_{c} = {[ \frac{Δ {Pd}_{Max}}{σ} ]}_{c} = {\frac{{d}_{Max}}{D} [ \frac{D Δ P}{σ} ]}_{c}$$

A critical value ΔP_{c} is defined such that only the surplus of energy present in comparison to this critical value, that is to say ΔP>ΔP_{c}, leads to the gas entrainment.

By considering that a rate K_{ΔP} of the work done by the pressure forces is used for the gas entrainment and by also including the critical conditions for gas entrainment behind the pocket, the flow of entrained gas is expressed by:

$${ψ}_{G , e} = \frac{{K}_{Δ P}}{6} \frac{{d}_{Max}}{σ} ( Δ P - Δ {P}_{c} ) \qquad ( 9 )$$

The parameter K_{ΔP}, as well as the critical value of the pressure jump ΔP_{c} necessary to accelerate the liquid between the gas pocket and the slug, are specifically determined.

### Determination of the Constant ΔP_{c}

The critical pressure jump ΔP_{c} is specific for each entrained gas flow calculation. It is determined by the model.
The following consideration is applied: If there is no gas, the surface velocity of the gas in the pipe is zero (U_{G}=0) and the liquid slug is not aerated. Therefore, when UG=0, the entrained gas flow must verify Ψ_{Ge}=Ψ_{G}=0 and ΔP=ΔP_{c}. Since U_{G}=0 under these conditions, the velocity of the mixture is equal to the surface velocity of the liquid (U_{L}=Uₘ).
For each flow condition considered by the model, a critical value ΔP_{c} is first calculated. To do this, the MB and MP models are applied by setting Ψ_{Ge}=Ψ_{G}=0 for U_{L}=Uₘ. The values for the velocities of the liquid in the slug and in the pocket are then obtained (V_{LB,c} and V_{LP,c}). The associated critical liquid flow is given by Ψ_{L,c}=V_{P}−U_{L}. Then the associated pressure jump is calculated:
ΔP_{c}=ρ_{L}Ψ_{L,c}(V_{LB,c}−V_{LP,c}). Thus a pressure jump value ΔP is obtained corresponding to the value of the critical pressure jump value ΔP_{c}. The value of the constant ΔP_{c} is therefore specific to each calculation, and must be calculated first.

### Determination of the Constant K_{ΔP}

The value of K_{ΔP} is obtained from experimental data representative of a flow behavior of a fluid of given properties in a pipe of a known geometry. By using the equality of gas flows Ψ_{G}=Ψ_{G,e},

$${K}_{Δ P} = \frac{6 σ {ψ}_{G}}{{d}_{Max} ( Δ P - Δ {P}_{c} )} = f ( {ψ}_{G} , {ψ}_{L} , σ , {d}_{Max} , Δ {P}_{c} , {V}_{LP} , {V}_{LB} )$$

So the constant K_{ΔP} is determined by using experimental measurements of a flow of a gas and of a liquid, Ψ_{G} and Ψ_{L}. To do this a campaign of experimental measurements must be conducted. Experimental data is collected in conditions of intermittent flow concerning: the pocket velocity V_{P} and the void fraction R_{G}. The gas and liquid flows are then determined experimentally: Ψ_{G}=R_{G}V_{P}−U_{G} and Ψ_{L}=R_{L}V_{P}−U_{L}. The MP and MB calculation models are applied by determining the values of ΔP_{c}, V_{LP} and V_{LB} associated with the experimental points considered.

The value of the constant KΔP thus obtained is independent of the conditions of a given velocity, and depends essentially on the diameter of the pipe and the properties of the fluids considered (surface tension and contamination level of the liquid). A value obtained with the help of experimental data representative of the industrial conditions considered (concerning the diameter and the properties of the fluids) can then be applied with calculations for entrained gas flow in industrial flow behavior conditions.

Finally, according to the invention, it is considered that the entrained gas flow cannot exceed a maximum value, written as Ψ_{G,Max}. In effect, the gas pocket has a velocity increasingly positive and greater than the average velocity of the gas in the slug. The average void fraction R_{G} is therefore always less than the void fraction obtained with an assumed uniform flow without shifting R_{G,nos}: R_{G}<R_{G,nos}=U_{G}/Uₘ. U_{G} is the surface velocity of the gas.

Since by definition R_{G} and V_{G} are positive,

R_{G,nos}V_{G}>R_{G}V_{G}=U_{G}>0 (10)

Therefore the flow of gas must agree with:

Ψ_{G}=R_{G}(V_{P}−V_{G})<R_{G,nos}(V_{P}−V_{G})<R_{G,nos}V_{P}−U_{G} (11)

The flow of gas therefore has a maximum value:

Ψ_{G,Max}=R_{G,nos}V_{P}−U_{G} (12)

In our model, this criterion is applied by using:

Ψ_{G,ent}=min(Ψ_{G,Max}, Ψ_{G,e}) (13)

### Resolution of the Problem

Thus, according to the invention, a gas-liquid intermittent flow within a pipe is physically modeled with the help of eleven independent relationships:
one relationship for the pocket velocity (equation 7);
three relationships for the gas flow (equation 1);
two relationships for the liquid flow (equation 3);
two hydrodynamic models adapted to the two flow areas (equations 7 and 8);
three relationships for linking the void fraction and the liquid fraction in each part of the flow (equation 5).

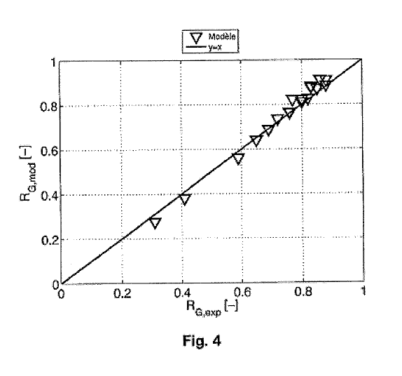

FIGS. 3 and 4 illustrate the effectiveness of the method for determining the entrained gas flow, and consequently the average void rate:

FIG. 3 shows a comparison between experimental measurements of an average void fraction (R_{G,exp}) and the associated prediction (R_{G,mod}) for a flow of a condensate in a pipe inclined with θ=45° and a strong pressure (40 bar). The experimental value is placed on the horizontal axis, and the associated prediction is placed on the vertical axis. The bisector y=x is also represented.

FIG. 4 shows a comparison between experimental measurements of an average void fraction (R_{G,exp}) and the associated prediction (R_{G,mod}) for a flow of a condensate in a pipe inclined with θ=75° and a weak pressure (10 bar). The experimental value is placed on the horizontal axis, and the associated prediction is placed on the vertical axis. The bisector y=x is also represented.

The experimental values stem from the following document:
Femschneider G. 1982. Écoulements gaz-liquide à poches et bouchons dans les conduits de section circulaire [Gas-liquid flows with pockets and slugs in circular section pipes]. Doctoral thesis, Institut National Polytechnique de Toulouse [Toulouse National Polytechnic Institute], France.

### Estimation of Load Losses Within the Pipe

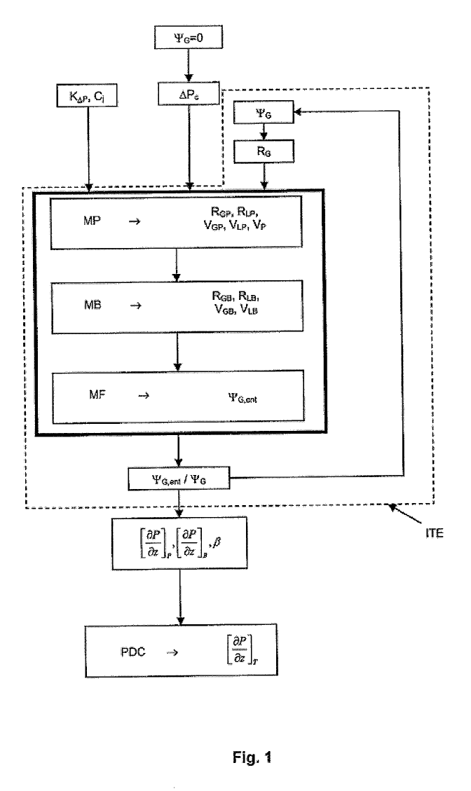

FIG. 1 illustrates the steps of the method. The eleven unknown quantities are:

(V_{P}, R_{GB}, R_{GP}, R_{LB}, R_{LP}, V_{GB}, V_{GP}, V_{LB}, V_{LP}, R_{G}, R_{L}).

These eleven unknown quantities are determined with the eleven independent relationships that constitute the flow behavior physical model. An iterative method is employed to resolve the problem. To that purpose a relaxation method for the average gas flow G is applied to each iteration.

### Initialization

It is necessary to define an initial value for the average gas flow Ψ_{G}. This initial value does not have any influence on the final result and can therefore be chosen completely arbitrarily.

### Iteration Loop (ITE)

The iteration loop has three successive stages:

First of all, the average void fraction over the pocket section (R_{GP}), the liquid fraction in the pocket (R_{LP}), and the average velocity of the gas in the pocket (V_{GP}) are determined with the help of a physical model describing the physics of the flow for each phase within the gas pocket.

Then the average void fraction over the slug section (R_{GB}), the liquid fraction in the slug (R_{LB}), the average velocity of the gas in the slug (V_{GB}), and the average velocity of the liquid in the slug (V_{LB}) are determined with the help of a model describing the physics of the flow for each phase within the liquid slugs.

Finally, with the help of the preceding calculations, the entrained gas flow Ψ_{G,ent} is determined from the third model.

Next, this entrained gas flow Ψ_{G,ent} is compared to the average gas flow Ψ_{G} given as input for the slug.

A new average gas flow Ψ_{G} is calculated from the entrained gas flow Ψ_{G,ent}. For example, the average of the two can be taken:

Ψ_{G}=(Ψ_{G}+Ψ_{G,ent})/2

This new average gas flow Ψ_{G} is given as input for the slug and a new calculation for the entrained gas flow Ψ_{G,ent} is made. It is recalled that the average gas flow is the gas flow obtained by the conservation equation of flows in an established intermittent flow behavior:

Ψ_{G}=R_{G}(V_{P}−V_{G})

So by providing a new Ψ_{G}, a new average void fraction is calculated over the entire section R_{G}. By imposing Ψ_{GB}=Ψ_{G} and Ψ_{GP}=Ψ_{G}, the MB and MP models thereby allow one to obtain new values for the gas and liquid velocities and fractions in the pocket and in the slug.

The iterations are stopped when the entrained gas flow meets a convergence criterion. For example, the following criterion can be chosen:

|(Ψ_{G,ent}−Ψ_{G})/Ψ_{G}|<10⁻³

### Calculation of the Load Losses (PDC)

Thus, thanks to this loop of iterations, the average void fractions in the liquid slug and in the pocket are determined. The velocities of the phases in these sections are also known.

The pocket fraction can then be determined. It is defined by: β=(L_{P}/L_{T}), where L_{P} is the length of the pocket section and LT=LP+LB is the total length (pocket and liquid slug). This is calculated with the help of the void fraction results: β=(R_{G}−R_{GB})/(R_{GP}−R_{GB}).

In an intermittent flow behavior, the total pressure gradient is given by:

[δP/δz]_{T}=β[δP/δz]_{P}+(1−β)[δP/δz]_{B},

where [δP/δz]_{P} and [δP/δz]_{B} are the pressure gradients in the pocket section and in the slug section. These pressure gradients in the pocket and slug sections depend uniquely on the parameters calculated by the model (phase fractions and phase velocities in each section). The model therefore allows the determination of total load losses, [δP/δz]_{T}, in an intermittent flow.

### Suitable Dimensioning of Installations

With the help of the model, different scenarios can be tested and thereby the properties of equipment suitable for the transport and the production of hydrocarbons can be selected.

For example, depending on the production conditions defined by the operator, several diameters of pipes can be installed. Among this range of diameters, the model according to the invention allows selecting those that allow minimizing load losses. A flow with a condensate with a low viscosity (0.4 mPas) and a surface tension equal to 12 mN/m in an inclined pipe is considered as an example. The gas and liquid volume flow rates are fixed at (Q_{G}=0.1 m³s⁻¹; Q_{L}=0.02 m³s⁻¹). Under these flow conditions, the load losses are 7300 kPa/m for a pipe with a 7.5 cm diameter, while they are only 1500 kPa/m for a pipe with a 15 cm diameter. The method developed here allows one to predict this result.

The method proposed here also finds applications in the dimensioning of separation equipment at the end of a slug-catcher type petroleum production line. This equipment is meant to muffle the fluctuations of the liquid outflow generated by the intermittent flow. Their dimensioning needs the knowledge of the fractions of gas and of liquid in the different sections of the flow, as well as the length of the pocket section and slug.

Therefore, the invention finds an industrial application in the exploitation of petroleum deposits, both for dimensioning production and hydrocarbon transport pipes, or for the simulation of the hydrodynamic behavior of the production and petroleum fluid transport pipes.

1. A method for dimensioning industrial installations where a two-phase mixture comprising a liquid phase and a gaseous phase flows according to a configuration comprising a succession of liquid slugs and gas pockets behind which gas is entrained, in which the flow behavior for each phase within a gas pocket and the flow behavior of each phase within a liquid slug are modeled with the help of a first physical model, and entrained gas flow is modeled with the help of a second physical model, characterized by comprising the following steps:
the second physical model is defined in which said entrained gas flow is proportional to a pressure variation between a gas pocket and a liquid slug behind this pocket, and in which a critical condition for formation of said entrained gas flow is taken into account, defined by a pressure variation such that pressure forces generated by this pressure variation are greater than the surface tension forces between the gas and the liquid;
said second model is initialized and calibrated with the help of experimental measurements;
a pressure gradient in the pocket, a pressure gradient in the slug and the ratio of one gas pocket length over one liquid slug length are determined with the help of an iterative method within which an entrained gas flow Ψ_{G,ent} is adjusted, calculated with the help of said second model, with an average gas flow Ψ_{G} obtained by a flow conservation equation of the intermittent flow established from said first physical flow model,
load losses within industrial installations are determined with the help of said pressure gradients and said ratio, and
the dimensions of industrial installations are determined so as to minimize said load losses.

2. A method according to claim 1, in which the entrained gas flow Ψ_{G,ent} is determined by considering that a rate K_{ΔP} of the work done by the pressure forces is used for the gas entrainment.

3. A method according claim 1, in which the entrained gas flow Ψ_{G,ent} is determined by taking into account a maximum value of the entrained gas flow through an assumption of a uniform and non-shifting flow.

4. A method according to claim 1, in which said first physical model comprises a stratified flow model based on the equality of the pressure gradients in the two phases.

5. A method according to claim 1, in which said first physical model comprises an annular flow model based on the equality of the pressure gradients in the two phases.

6. A method according to claim 1, in which said first physical model comprises a drift-flux model.

7. A method according to claim 1, in which the iterative method comprises a stopping criterion defined by the following convergence criterion:

|(Ψ_{G,ent}−Ψ_{G})/Ψ_{G}|<10⁻³

8. A method according to claim 1, in which the dimensions of industrial installations are determined by determining the load losses for different values of given geometric properties of installations, and those installations are selected having geometric properties minimizing the load losses.

9. A method according to claim 1, in which the industrial installations are petroleum effluent pipes.

10. A method according to claim 1, in which the industrial installations are slug-catcher type petroleum separation equipment, and in which the dimensions of this separation equipment is determined by determining the fractions of gas and liquid and the relative lengths of one pocket and one liquid slug.
